(19) United States
(12) Patent Application Publication
(10) Pub. No.: US 2025/0312858 A1
(43) Pub. Date: Oct. 9, 2025

(54) CROPPING CONTROL SYSTEMS FOR HOT MILL OPERATIONS

(71) Applicant: Novelis Inc., Atlanta, GA (US)

(72) Inventors: Roberto Armbrust de Freitas Quintal, Woodstock, GA (US); Felipe Mappa Franca Rocha, Acworth, GA (US); Carlos Alberto Jorio Eboli, Acworth, GA (US)

(73) Assignee: Novelis Inc., Atlanta, GA (US)

(21) Appl. No.: 18/864,968

(22) PCT Filed: May 2, 2023
(86) PCT No.: PCT/US2023/020672

§ 371 Date: Nov. 12, 2024

Related U.S. Application Data
(60) Provisional application No. 63/364,684, filed on May 13, 2022.

(51) Int. Cl. B23D 36/00; B23D 15/08

(52) U.S. Cl. CPC B23D 36/0083; B23D 15/08

(57) ABSTRACT

A cropping system for cropping a metal slab (102) includes at least one of a cropping length (1035, 524) system and a slab positioning system. The cropping length (1035, 524) system includes an optical sensor (118A, 118B, 318A, 318B, 518) for detecting a defect in an end (1031) of the metal slab (102), and the cropping length (1035, 524) system may determine a cropping location on the metal slab (102) based on the detected defect. The slab positioning system includes an optical sensor (118A, 118B, 318A, 318B, 518) for measuring a position of the end (1031) of the metal slab (102) relative to a cropping device of the cropping system.

### REFERENCE TO RELATED APPLICATION

This application claims the benefit of U.S. Provisional Patent Application No. 63/364,684, filed on May 13, 2022, and entitled CROPPING CONTROL SYSTEMS AND METHODS FOR HOT MILL OPERATIONS, the content of which is hereby incorporated by reference in its entirety.

### FIELD OF THE INVENTION

This application relates to metalworking generally, and more specifically to systems and methods for controlling cropping of a metal slab, particularly, but not limited to, during hot mill operations.

### BACKGROUND

Metal processing of a metal slab such as hot mill operations often requires cropping of one or both ends of the metal slab (commonly referred to as the head and tail of the metal slab) to remove defects such as rollover and/or delamination.

Traditionally, the length of a particular end to be cropped has been determined by an operator based on his or her evaluation of the defect, and the slab is manually positioned under the cropping device for cropping and without any other guidance. While operators may be skilled at making such evaluations and positioning of the slab, existing techniques are prone to operator error or subjectivity, and cropping lengths may vary depending on the operator.

Other traditional operations may use an encoder on a roller of a roller table to measure a speed of the slab and thus the length of slab under the cropping device, but encoders are inaccurate because the metal slab slips on the rolls, thereby generating a length calculation error. Yet other traditional techniques have included Doppler to measure a length of the metal slab, but such techniques are inaccurate and unreliable because surface roughness of the metal slab causes a speed calculation error, and such devices are unable to measure metal slabs moving at slow speeds that may be required for proper metal slab positioning. As such, existing techniques are subject to accuracy and repeatability issues, leading to increased material waste (e.g., by over-cropping the metal slab) and/or leaving defects in the slab (e.g., by under-cropping the metal slab), which may cause issues during subsequent metal processing.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a cropping system for cropping a metal slab includes a slab positioning system. The slab positioning system includes an optical sensor for measuring a position of an end of the metal slab relative to a cropping device of the cropping system. The slab positioning system also includes a controller communicatively coupled to the optical sensor. The controller may generate a position control response based on the measured position of the end of the metal slab from the optical sensor.

According to some embodiments, a cropping system for cropping a metal slab includes a slab positioning system. The slab positioning system includes an optical sensor for detecting an end of the metal slab and a controller communicatively coupled to the optical sensor. In some embodiments, the controller may receive visual data from the optical sensor including the detected end of the metal slab, measure a length of a target region of the end of the metal slab based on the received visual data, and generate a position control response based on the measured length of the target region of the end of the metal slab.

According to various embodiments, a method of cropping a metal slab with a cropping system includes receiving, from an optical sensor, a measured position of an end of the metal slab relative to a cropping device of the cropping system, and controlling the end of the metal slab relative to the cropping device based on the measured position of the end of the metal slab.

According to certain embodiments, a cropping system for cropping a metal slab includes a cropping length system. The cropping length system includes an optical sensor for detecting a defect in an end of the metal slab and a controller communicatively coupled to the optical sensor. The controller may determine a cropping location in the metal slab based on the detected defect by the optical sensor.

According to various embodiments, a method of cropping a metal slab with a cropping system includes receiving, from an optical sensor, a detection of a defect in an end of the metal slab, determining a cropping location in the metal slab based on the detected defect by the optical sensor, and controlling the metal slab relative to a cropping device of the cropping system based on the determined cropping location.

According to some embodiments, a cropping system for cropping a metal slab includes a cropping length system and a slab positioning system. The cropping length system includes a first optical sensor for detecting a defect in an end of the metal slab. The slab positioning system includes a second optical sensor for measuring a position of the end of the metal slab relative to a cropping device of the cropping system. In some embodiments, the cropping system includes a controller, which may determine a cropping location in the metal slab based on the detected defect from the first optical sensor and determine an actual position of the cropping location relative to the cropping device based on the measured position of the end of the metal slab from the second optical sensor. In some embodiments, the controller may generate a position control response based on the actual position of the cropping location relative to the cropping device.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1A illustrates a cropping system according to embodiments with a metal slab in a first position relative to a cropping device.

FIG. 1B is a top view of the cropping system of FIG. 1 with a sensing region illustrated on the metal slab.

FIG. 2A illustrates the cropping system of FIGS. 1A-B with the metal slab in a second position relative to the cropping device.

FIG. 2B is a top view of the cropping system of FIG. 2A with sensing regions illustrated on the metal slab.

FIG. 3 illustrates a cropping system according to embodiments with a metal slab in a first position relative to a cropping device.

FIG. 4 illustrates the cropping system of FIG. 3 with the metal slab in a second position relative to the cropping device.

FIG. 5 illustrates a cropping system according to embodiments.

FIG. 6 illustrates a cropping system according to embodiments.

FIG. 7 is an image of a metal slab obtained by the cropping system of FIG. 6.

FIG. 8 illustrates a cropping system according to embodiments.

FIG. 9 is a thermal image of a metal slab obtained by the cropping system of FIG. 8.

FIG. 10 is a perspective view a cropping system according to embodiments.

FIG. 11 is an end view of the cropping system of FIG. 10.

FIG. 12 is a top view of the cropping system of FIG. 10.

FIG. 13 is an image of a defect obtained by the cropping system of FIG. 10.

### DETAILED DESCRIPTION

Described herein are systems and methods for cropping a metal slab. In some embodiments, the systems and methods provided herein may be particularly useful for cropping metal slabs of aluminum or aluminum alloys; however, in other embodiments, the systems and method described herein may be used with any type of metal slab as desired. In some embodiments, the systems and methods described herein provide an improved identification of a defect in an end of the metal slab (e.g., in a head or a tail of the metal slab) and determination of a cropping length based on the detected defect. Additionally, or alternatively, the disclosed systems and methods may provide an improved measurement of a cropping length on the metal slab. In certain embodiments, the systems and methods provided herein may generate or cause various output responses based on the determined cropping length or measurement of the cropping length. The disclosed systems and methods may provide an optimized cropping operation for improving accuracy and minimizing waste compared to traditional cropping systems. Various other benefits and advantages may be realized with the systems and methods provided herein, and the aforementioned advantages should not be considered limiting.

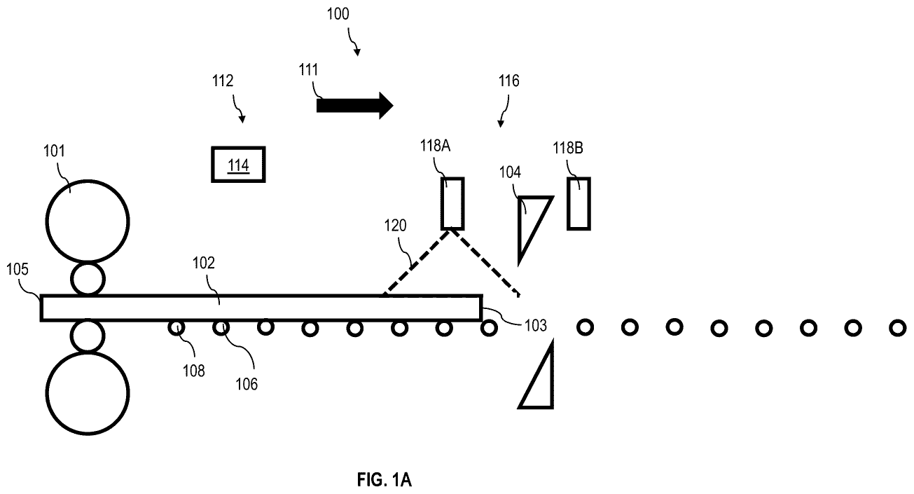

FIGS. 1A-B and 2A-B illustrate a cropping system 100 for a metal slab 102 and with a cropping control system 112 according to various embodiments. In certain embodiments, the cropping system 100 optionally may be downstream from a hot rolling mill 101, although in other embodiments the cropping system 100 may be provided at other locations as desired. In addition to the cropping control system 112, the cropping system 100 generally includes one or more cropping devices 104 and one or more supports 106. The one or more supports 106 may be various devices or mechanisms suitable for supporting the metal slab 102 as the metal slab 102 moves through the cropping system 100 (represented by arrow 111). In the embodiment illustrated, the one or more supports 106 includes a plurality of rollers 108, and such rollers 108 may be supported by a table or other support structure. The cropping device 104 may be various devices or mechanisms suitable for cropping or shearing the metal slab 102 as desired, including but not limited to heavy shears or light shears.

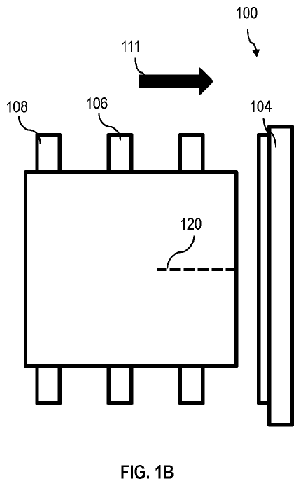

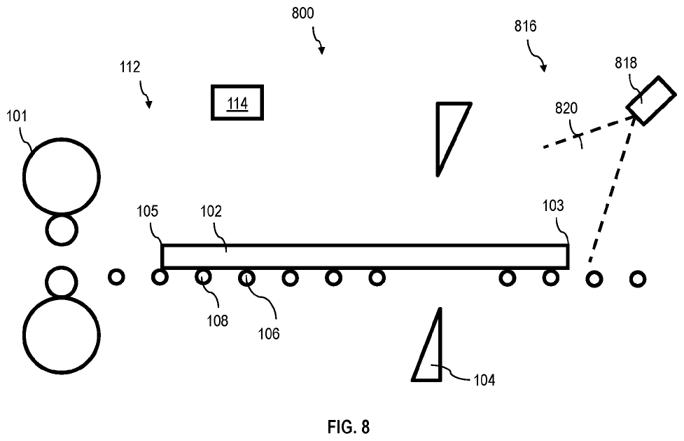

In certain embodiments, such as a result of rolling by the hot rolling mill 101, at least one of a head end 103 or a tail end 105 of the metal slab 102 may have a defect and/or otherwise need to be cropped before the metal slab 102 can be further processed. In such embodiments, the cropping control system 112 may be used to improve a cropping operation performed by the cropping device 104. In various embodiments, the cropping control system 112 includes a controller 114 and one or more of a slab positioning system (see, e.g., FIGS. 1A-B, 2A-B, and 3-9) and/or a cropping length system (see, e.g., FIGS. 10-14). As such, while a slab positioning system 116 is illustrated in FIGS. 1 and 2, in other embodiments, the cropping system 100 may include just a cropping length system or both a slab positioning system and a cropping length system. As discussed in detail below, the slab positioning system of the cropping control system 112 may be utilized to determine and/or control a position the metal slab 102 relative to the cropping device 104 for the cropping operation, and the cropping length system may be utilized to determine and/or control how much of a particular end should be cropped during a cropping operation.

The controller 114 of the cropping control system 112 may include one or more processing units and/or one or more memory devices. The processing unit of the controller 114 may be various suitable processing devices or combinations of devices including but not limited to one or more application specific integrated circuits, digital signal processors, digital signal processing devices, programmable logic devices, field programmable gate arrays, processors, controllers, micro-controllers, microprocessors, other electronic units, and/or a combination thereof. The one or more memory devices of the controller 114 may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

In certain embodiments, the controller 114 optionally includes an associated user interface, including but not limited to a graphical user interface or a human machine interface, such that the controller 114 may obtain information from a user and/or provide information to the user. In such embodiments, the user interface and/or human machine interface may be on the controller 114 itself or may be at a location remote from the controller 114. Additionally, or alternatively, the controller 114 optionally may include various communication modules such that the controller 114 may receive and/or send information as desired. Non-limiting examples of communication modules may include systems and mechanisms enabling wired communication and/or wireless communication (e.g., near field, cellular, Wi-Fi, Bluetooth®, Bluetooth Low Energy, etc.).

In certain embodiments, the controller 114 is communicatively coupled to the cropping device 104 and the cropping length system and/or the slab positioning system for controlling a cropping operation based on information from the cropping length system and/or the slab positioning system as discussed in detail below.

### Slab Positioning System

In various embodiments, the cropping control system 112 includes a slab positioning system for determining and/or controlling a position the metal slab 102 relative to the cropping device 104 during a cropping operation. Such slab positioning systems may provide an improved detection and/or control of the metal slab 102 relative to the cropping device 104.

FIGS. 1A-B and 2A-B illustrate the cropping control system 112 with an example of a slab positioning system 116. As illustrated in FIGS. 1A-B and 2A-B, in certain embodiments, the slab positioning system 116 includes one or more optical sensors 118 positioned relative to the cropping device 104 and for measuring a position of an end of the metal slab 102 relative to the cropping device 104. In FIGS. 1A-B and 2A-B, the slab positioning system 116 is illustrated measuring the head end 103 of the metal slab 102 and the slab positioning system 116 is discussed in the context of measuring the head end 103. However, the slab positioning system 116 may similarly be used to measure a position of the tail end 105 of the metal slab 102.

In the embodiment of FIGS. 1A-B and 2A-B, the slab positioning system 116 includes two optical sensors 118A-B where the optical sensor 118A is provided upstream from the cropping device 104 and the optical sensor 118B is provided downstream from the cropping device 104. However, any number of optical sensors 118 may be utilized in other embodiments. The one or more optical sensors 118 may be various types of optical sensors as desired, including but not limited to laser-based optical sensors, cameras for various wavelengths as desired (e.g., ultraviolet cameras, visible light cameras, infrared cameras, etc.), machine vision cameras, combinations thereof, and/or other optical sensors as desired. In some non-limiting examples, the optical sensors 118 may obtain and/or output visual data of the metal slab 102, although they need not in other embodiments.

In the embodiment of FIGS. 1A-B and 2A-B, the optical sensors 118A-B are laser-based sensors. In this embodiment, each optical sensor 118A-B is installed above a passline for the metal slab 102 and optionally centered on the support 106. As best illustrated in FIGS. 1B and 2B, each optical sensor 118A-B generates a sensing region 120 (e.g., laser) in a plane that extends parallel to the rolling direction 111. In certain embodiments, the optical sensors 118A-B may automatically provide a measurement of a position of the head end 103 of the metal slab 102 relative to the cropping device 104. In some examples, the optical sensors 118A-B may use a projected laser line to measure a cross-sectional 3D geometry of portions or surfaces of the metal slab 102 and/or other parts. In other embodiments, the optical sensors 118A-B may automatically measure the head end 103 using other techniques as desired. As an example, the optical sensor 118A may measure a position of the head end 103 of the metal slab 102 upstream from the cropping device 104 (FIGS. 1A-B), and the optical sensor 118B may measure a position of the head end 103 of the metal slab 102 downstream from the cropping device 104 (FIGS. 2A-B). In various embodiments, based on the detected position of the head end 103 from the optical sensors 118 relative to the cropping device 104, the controller 114 of the cropping control system 112 may generate a position control response. In some embodiments, the position control response from the controller 114 based on the detected position from the slab positioning system 116 may include generating an alert (e.g., text, audio, image, etc.) on a display of a human machine interface associated with the controller 114. In such embodiments, the alert may include the detected position of the head end 103, and optionally the alert may include a comparison (or other indication) of the detected position relative to a desired position of the head end 103 relative to the cropping device 104.

Additionally, or alternatively, the position control response from the controller 114 may include controlling a position of the metal slab 102 relative to the cropping device 104. In such embodiments, the position control response may include actuating positioning equipment such as but not limited to the rollers 108. In such embodiments, actuating the positioning equipment may move the metal slab 102 upstream or downstream relative to the cropping device 104 as desired and/or such that the metal slab 102 is at a desired (e.g., predetermined or detected) position relative to the cropping device 104. As one non-limiting example, based on a detection by the optical sensor 118A that the head end 103 is upstream from the cropping device 104, the controller 114 may actuate the positioning equipment such that the metal slab 102 is moved downstream. In such embodiments, the metal slab 102 optionally may be moved downstream until the optical sensor 118B detects the head end 103 is downstream from the cropping device 104 and/or until the head end 103 is at a desired position downstream from the cropping device 104. As another non-limiting example, based on a detection by the optical sensor 118B that the head end 103 is downstream from the cropping device 104 but less than or greater than a desired distance relative to the cropping device 104, the controller 114 may control the positioning equipment to move the metal slab 102 upstream or downstream to position the metal slab 102 at the desired position. Various other position controls may be implemented by the controller 114 based on the position information from the slab positioning system 116 with the optical sensors 118, and the aforementioned examples should not be considered limiting.

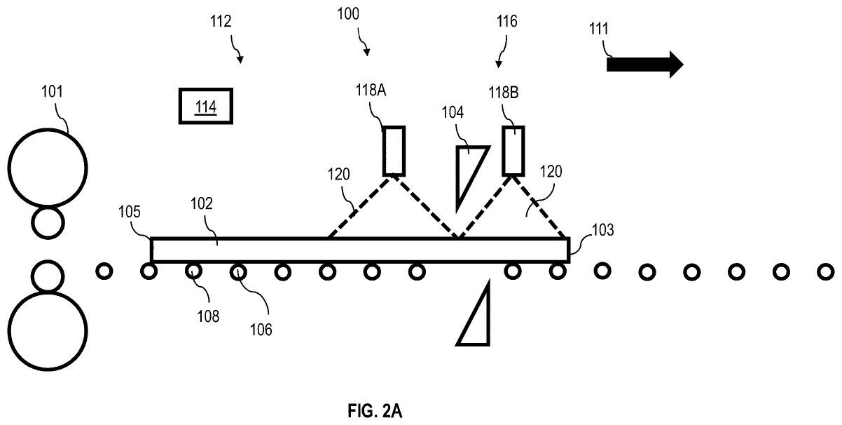

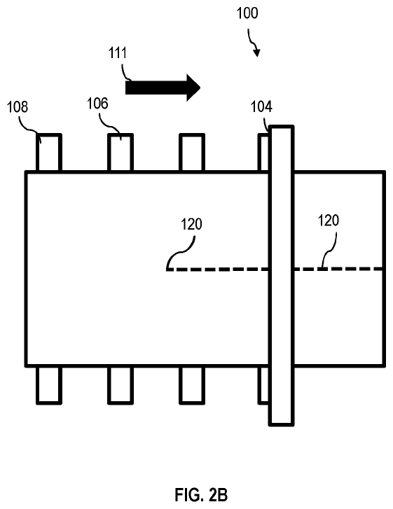

FIGS. 3 and 4 illustrate another cropping system 300 that is substantially similar to the cropping system 100 and includes a slab positioning system 316. The slab positioning system 316 is substantially similar to the slab positioning system 116 except that the slab positioning system 316 includes a different type of optical sensors 318A-B. However, similar to the optical sensors 118A-B, the optical sensors 318A-B are laser-based sensors installed above a passline for the metal slab 102 and that generate sensing regions 320 in planes extending parallel to the rolling direction 111. In these embodiments, similar to the optical sensors 118A-B, the optical sensors 318A-B may automatically provide a measurement of a position of the head end 103 of the metal slab 102 relative to the cropping device 104. FIG. 3 illustrates the optical sensor 318A measuring a position of the head end 103 of the metal slab 102 upstream from the cropping device 104, and FIG. 4 illustrates the optical sensor 318B measuring a position of the head end 103 of the metal slab 102 downstream from the cropping device 104. Similar to the cropping system 100, the cropping system 300 may include the controller 114 for controlling at least a portion of the positioning of the metal slab 102 and/or cropping operation based on the information from the slab positioning system 316.

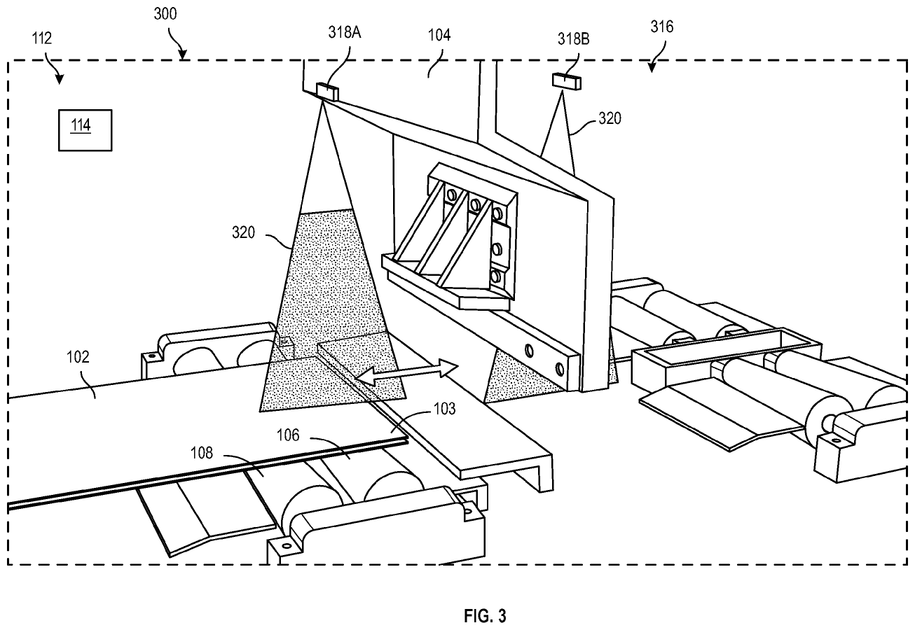

FIG. 5 illustrates another cropping system 500 that is substantially similar to the cropping system 100 and includes a slab positioning system 516. Compared to the slab positioning system 116, the slab positioning system 516 includes an optical sensor 518 that is a laser speed meter that directs a laser 520 onto the metal slab 102. In this embodiment, the optical sensor 518 may be provided at a known distance 522 from the cropping device 104. In such embodiments, based on the known distance 522 and a scanned distance or length 524 measured by the optical sensor 518, the controller 114 may determine the position of the head end 103 relative to the cropping device 104. As a non-limiting example, if the known distance 522 is 250 cm, and the scanned length 524 is 275 cm, the controller may determine the position of the head end 103 is 25 cm downstream from the cropping device 104. Similar to the slab positioning systems 516, various position control responses may be implemented based on the determined position of the head end 103.

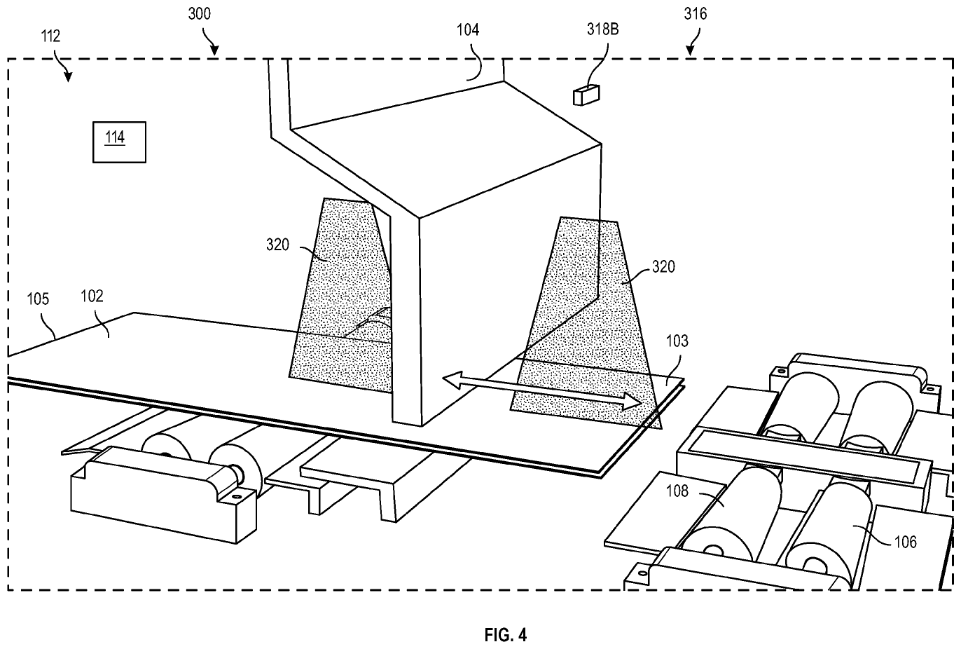

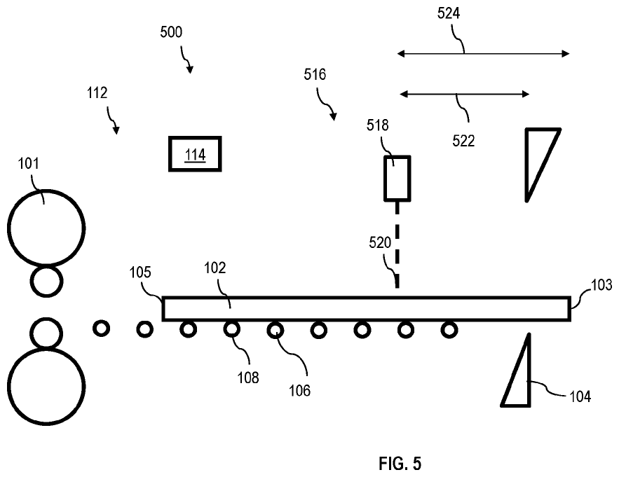

FIGS. 6 and 7 illustrate another cropping system 600 that is substantially similar to the cropping system 100 and includes a slab positioning system 616. Compared to the slab positioning system 116, the slab positioning system 616 includes a camera 618 having a sensing region 620. The camera 618 may be various types of cameras as desired, including but not limited to optical or video cameras, single or multi-stereo cameras, RGB-D cameras, and/or other types of cameras as desired, either alone or in any combination. While a single camera 618 is illustrated, in other embodiments, the slab positioning system 616 may include a plurality of cameras, and in such embodiments, the cameras need not be a same type of camera. Moreover, the camera(s) 618 may be provided at various positions or orientations as desired.

In certain embodiments, the camera 618 may be calibrated using various techniques or mechanisms as desired such that a defined portion of the visual data from the camera 618 (e.g., a pixel in an image or video) corresponds to a known measurement (e.g., millimeter). In such embodiments, the camera 618 may detect the portion of the metal slab 102 within the sensing region 620, and the length or position from the head end 103 may be automatically determined based on the calibration. FIG. 7 illustrates an example of the metal slab 102 and a detected portion (red line 628) of the metal slab 102 using the slab positioning system 616. In embodiments such as the slab positioning system 616 that include optical or video cameras, various supplemental devices, techniques, or mechanisms may be utilized to facilitate detection of the metal slab 102 on the supports 106 and/or to improve precision of the detected metal slab 102. Non-limiting examples of such supplemental devices, techniques, or mechanisms may include filters for enhancing a contrast between the metal slab 102 and the supports 106, lighting devices for highlighting the metal slab 102, lighting devices for enhancing contrast between the metal slab 102 and the supports 106, combinations thereof, and/or other devices, techniques, or mechanisms as desired.

In various embodiments, in addition to detecting the position of the head end 103 of the metal slab 102, the slab positioning system 616 with the camera 618 optionally may allow a cropping area to be defined. As a non-limiting example, based on visual data from the camera 618, the controller 114 may define an area to be cropped on the visual data. Additionally, or alternatively, the visual data may be provided to an operator (e.g., on a human machine interface), and the operator may provide an identification of a portion of the metal slab 102 to be cropped. In such an embodiment, the controller may determine the cropping area identified by the operator using the calibrated visual data from the camera 618. Additionally, or alternatively, the slab positioning system 616 with the camera 618 may allow for an estimation of a volume of the metal slab 102 being cropped. As an example, based on a known or detected thickness of the metal slab 102 and the defined cropping area, the controller 114 may determine a volume to be cropped using the calibrated visual data from the camera 618.

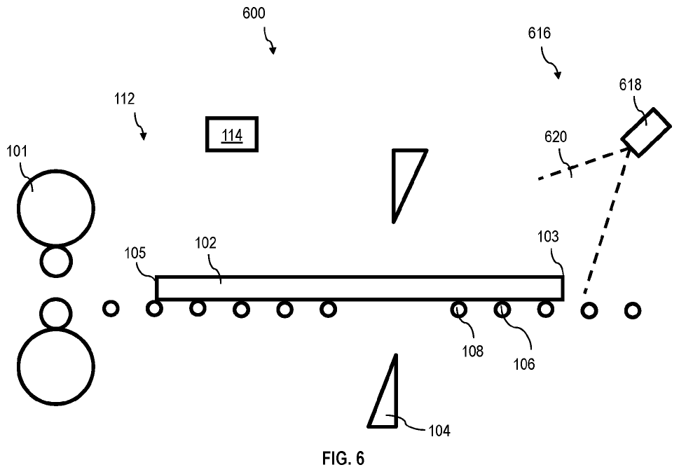

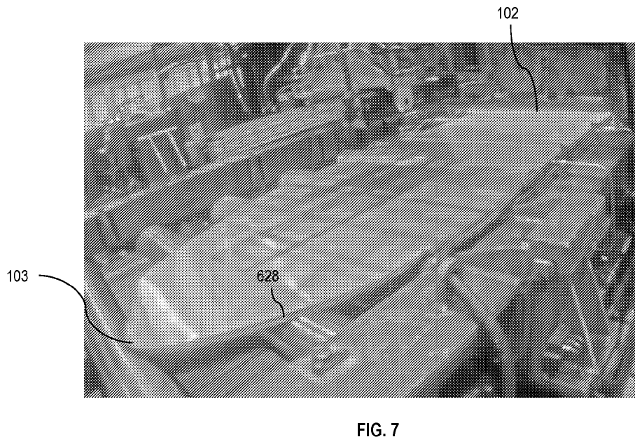

FIGS. 8 and 9 illustrate another cropping system 800 that is substantially similar to the cropping system 100 and includes a slab positioning system 816. Compared to the slab positioning system 116, the slab positioning system 816 includes a thermal camera 818 having a sensing region 820. As best illustrated in FIG. 9, a thermal image or video from the thermal camera 818 may facilitate detection of the metal slab 102 because the metal slab 102 is significantly hotter than its environment and thus highlighted in the thermal image. In this embodiment, the head end 103 of the metal slab 102 may be detected based on the initial detection of the highlighted head end 103. As mentioned, regardless of the particular slab positioning system used with the cropping control system 112, the controller 114 may use the information from the slab positioning system to generate one or more position control responses.

Referring back to FIGS. 1 and 2, a method of controlling a cropping operation using the slab positioning system 116 may include receiving, by the controller 114, a detected position of the head end 103 (and/or the tail end) of the metal slab 102 from one or both optical sensors 118A-B. The method includes generating, by the controller 114, a position control response based on the detected position of the head end 103. In some embodiments, generating the position control response includes generating an alert or alarm to an operator using a human machine interface and/or controlling a position of the metal slab 102 relative to the cropping device 104. The method may include cropping the metal slab 102 with the cropping device 104 based on the metal slab 102 being at a desired position relative to the cropping device 104. Various other processes may be performed using the slab positioning system 116, and the aforementioned control process should not be considered limiting.

### Cropping Length System

In certain embodiments, and as previously mentioned, the cropping control system 112 includes the cropping length system for determining and/or controlling how much of a particular end should be cropped during a cropping operation. The cropping length system may be provided with the slab positioning systems described herein, although it need not be in other embodiments.

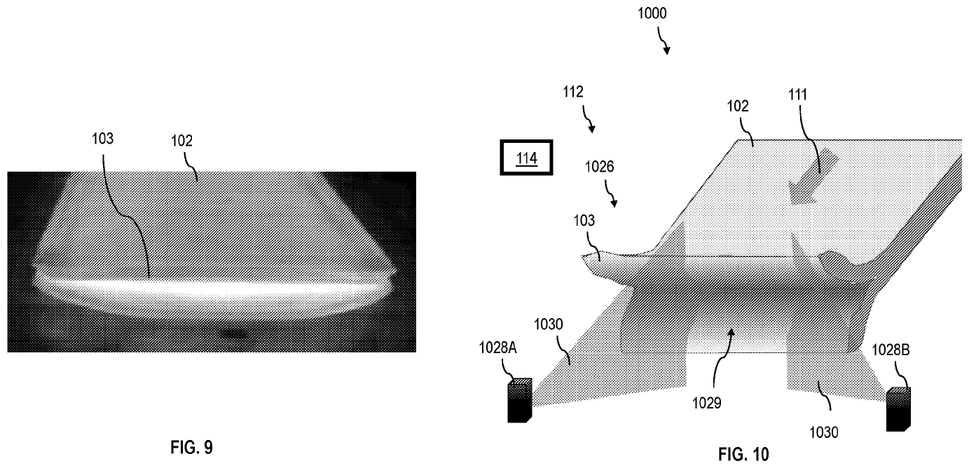

FIGS. 10-13 illustrate an example of a cropping system 1000 where the cropping control system 112 includes a cropping length system 1026. In certain embodiments, the cropping length system 1026 includes one or more optical sensors 1028 positioned relative to a passline of the metal slab 102 (e.g., as defined by the supports 106 in FIGS. 11-13) and for measuring an end of the metal slab 102. In the embodiment of FIGS. 10-15, the optical sensors 1028 are illustrated as measuring the head end 103, but the cropping length system 1026 may similarly measure the tail end 105.

In the embodiment of FIGS. 10-13, the cropping length system 1026 includes two optical sensors 1028A-B. The one or more optical sensors 1028 may be various types of optical sensors as desired, including but not limited to laser-based optical sensors, thermal (e.g., infrared) cameras, visible light cameras, other wavelength cameras, machine vision cameras, combinations thereof, and/or other optical sensors as desired. In some non-limiting examples, the optical sensors 1028 may obtain and/or output visual data of the metal slab 102, although they need not in other embodiments. In the embodiment of FIGS. 10-14, the optical sensors 1028A-B are laser-based sensors with sensing regions 1030 (e.g., lasers). In some examples, the optical sensors 1028A-B may use a projected laser line to measure a cross-sectional 3D geometry of portions or surfaces of the metal slab 102 and/or other parts. In the embodiment of FIGS. 10-14 and as best illustrated in FIG. 10, the optical sensors 1028A-B being configured to measure the head end 103 in the thickness direction may allow for the cropping length system 1026 to detect and/or measure a defect in the metal slab 102, such as a delamination cavity 1029 in the head end 103 of the metal slab 102.

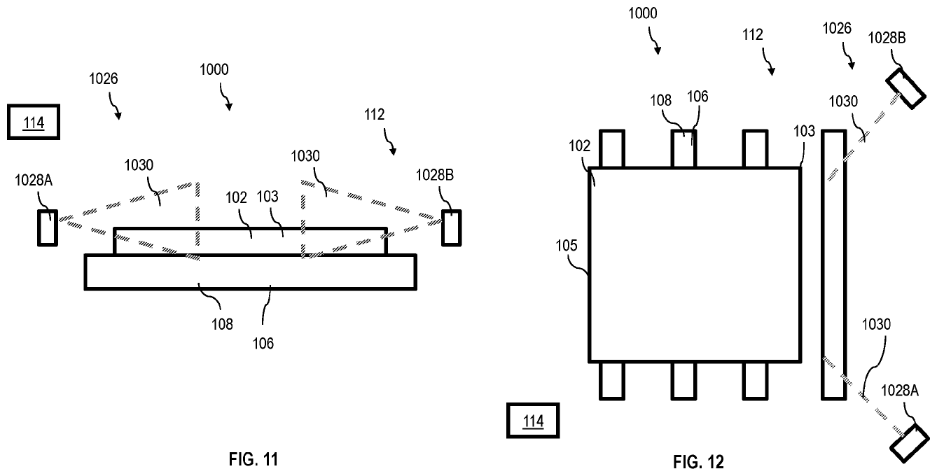

As best illustrated in FIGS. 11 and 12, the optical sensors 1028A-B are provided on opposing sides of the passline for the metal slab 102. The optical sensors 1028A-B may be provided at various heights relative to the passline as desired, and the height of the sensors illustrated in FIG. 11 should not be considered limiting. Moreover, the optical sensors 1028A-B need not be at the same height. The optical sensors 1028A-B may similarly be provided at various distances relative to the passline of the metal slab 102, and the distances illustrated should not be considered limiting.

In some embodiments, and as best illustrated in FIG. 12, the optical sensors 1028A-B are optionally oriented at an oblique angle relative to a width direction of the metal slab 102. As non-limiting examples, one or both optical sensors 1028A-B may be provided at an angle from 30° to less than 90° relative to the width direction of the metal slab 102, such as from 45° to less than 90°, such as from 60° to less than 90°. In other embodiments, one or both optical sensors 1028A-B may be provided at a right angle (or 90°) relative to the width direction of the metal slab 102.

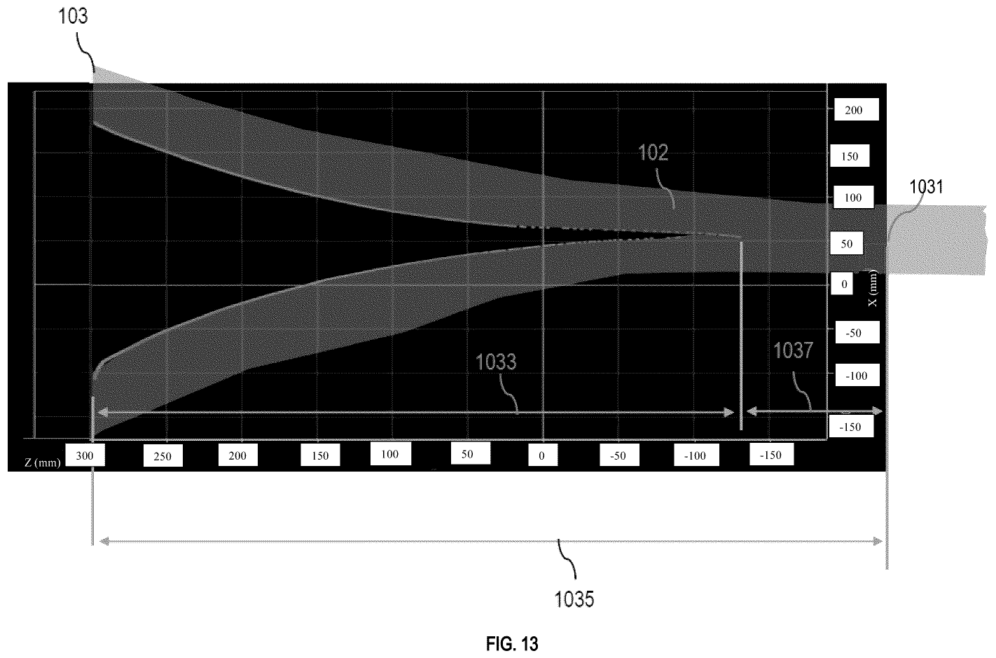

In certain embodiments, the optical sensors 1028A-B may automatically provide a measurement of the head end 103 of the metal slab 102. In various embodiments, and as illustrated in FIG. 13, the optical sensors 1028A-B may provide a measurement of at least a portion 1033 of the delamination cavity 1029 in the head end 103. As illustrated in FIG. 13, in some embodiments, the optical sensors 1028A-B may be unable to measure up to an end 1031 of the delamination cavity 1029 (i.e., the end 1031 is hidden from optical detection). In such embodiments, if the detected portion 1033 were determined to be the cropping length, a portion of the delamination defect would remain in the metal slab 102 and potentially cause issues during subsequent processing of the metal slab 102. In various embodiments, an actual length 1035 of the delamination cavity 1029 may be determined by the controller 114 (and/or an operator) by adding an adjustment value 1037 for the hidden length to the portion 1033 measured by the optical sensors 1028A-B. In various embodiments, the adjustment value 1037 may be determined statistically, by modelling, and/or using other techniques as desired. In certain embodiments, the adjustment value 1037 may be predetermined; however, in other embodiments, the adjustment value 1037 may be determined based on the portion 1033 of the delamination cavity 1029 and/or other characteristics or properties of the metal slab 102.

In various embodiments, based on the measurements from the optical sensors 1028A-B and/or the determined actual length 1035 of the delamination cavity 1029 in the head end 103, the controller 114 of the cropping control system 112 may generate a length control response. In some embodiments, the length control response may include generating an alert (e.g., text, audio, image, etc.) on a display of a human machine interface associated with the controller 114. In such embodiments, the alert may include the determined cropping length, or the distance from the head end 103 at which cropping should be performed by the cropping device. Additionally, or alternatively, the length control response from the controller 114 may include controlling the cropping device 104 such that the metal slab 102 is cropped at the determined cropping length. Optionally, such control may optionally include providing the determined cropping length to the slab positioning system, and the slab positioning system may position the metal slab based on the determined cropping length. Various other position controls may be implemented by the controller 114 based on the determined cropping length information from the cropping length system 1026, and the aforementioned examples should not be considered limiting.

A method of controlling a cropping operation using the cropping length system 1026 may include receiving, by the controller 114, a measured length of at least the portion 1033 of the delamination cavity 1029 from one or both optical sensors 1028A-B. The method optionally includes determining an actual delamination cavity length, which may be a minimum cropping length, by adding the adjustment value to the measured cavity length. In some embodiments, the method includes determining, by the controller 114, the adjustment value based on modelling or other techniques as desired. The method includes generating, by the controller 114, a length control response based on the determined cropping length for the head end 103. In some embodiments, generating the length control response includes generating an alert or alarm to an operator using a human machine interface and/or controlling a position of the metal slab 102 relative to the cropping device 104 such that the cropping device 104 crops the metal slab at the determined cropping length. Optionally, the method includes controlling the position of the metal slab 102 using one or more slab positioning systems described herein. Various other processes may be performed using the cropping length system 1026, and the aforementioned control process should not be considered limiting.

### Illustrations

A collection of exemplary embodiments is provided below, including at least some explicitly enumerated as “Illustrations” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.
Illustration 1. A cropping system for cropping a metal slab, the cropping system comprising a slab positioning system, the slab positioning system comprising: an optical sensor configured to measure a position of an end of the metal slab relative to a cropping device of the cropping system; and a controller communicatively coupled to the optical sensor, the controller configured to generate a position control response based on the measured position of the end of the metal slab by the optical sensor.
Illustration 2. The cropping system of any preceding or subsequent illustrations or combination of illustrations, wherein the optical sensor is a first optical sensor configured to measure the position of the end of the metal slab upstream from the cropping device, and wherein the slab positioning system further comprises a second optical sensor configured to measure the position of the end of the metal slab downstream from the cropping device.
Illustration 3. The cropping system of any preceding or subsequent illustrations or combination of illustrations, wherein the optical sensor is positioned above a passline for the metal slab through the cropping system, and wherein the optical sensor is configured to measure the metal slab in a plane that is parallel to a processing direction of the metal slab.
Illustration 4. The cropping system of any preceding or subsequent illustrations or combination of illustrations, wherein the optical sensor is a laser-based optical sensor.
Illustration 5. The cropping system of any preceding or subsequent illustrations or combination of illustrations, wherein the optical sensor is a thermal camera.
Illustration 6. The cropping system of any preceding or subsequent illustrations or combination of illustrations, wherein the controller is configured to position the metal slab relative to the cropping device or generate a display on a human machine interface as the position control response.
Illustration 7. The cropping system of any preceding or subsequent illustrations or combination of illustrations, wherein the optical sensor is a machine vision camera positioned above a passline for the metal slab through the cropping system.
Illustration 8. A cropping system for cropping a metal slab, the cropping system comprising a slab positioning system, the slab positioning system comprising: an optical sensor configured to detect an end of the metal slab; and a controller communicatively coupled to the optical sensor, the controller configured to: receive visual data from the optical sensor comprising the detected end of the metal slab; measure a length of a target region of the end of the metal slab based on the received visual data; and generate a position control response based on the measured length of the target region of the end of the metal slab.
Illustration 9. The cropping system of any preceding or subsequent illustrations or combination of illustrations, wherein the optical sensor is a machine vision camera positioned above a passline for the metal slab through the cropping system.
Illustration 10. The cropping system of any preceding or subsequent illustrations or combination of illustrations, wherein the optical sensor is a thermal camera.
Illustration 11. A method of cropping a metal slab with a cropping system, the method comprising: receiving, from an optical sensor, a measured position of an end of the metal slab relative to a cropping device of the cropping system; and controlling the end of the metal slab relative to the cropping device based on the measured position of the end of the metal slab.
Illustration 12. The method of any preceding or subsequent illustrations or combination of illustrations, wherein the optical sensor is a first optical sensor upstream from the cropping device, wherein the method further comprises receiving, from a second optical sensor downstream from the cropping device, a measured position downstream from the cropping device of the end of the metal slab relative to the cropping device.
Illustration 13. The method of any preceding or subsequent illustrations or combination of illustrations, further comprising cropping the metal slab based on the measured position of the end of the metal slab.
Illustration 14. A cropping system for cropping a metal slab, the cropping system comprising a cropping length system, the cropping length system comprising: an optical sensor configured to detect a defect in an end of the metal slab; and a controller communicatively coupled to the optical sensor, the controller configured to determine a cropping location in the metal slab based on the detected defect by the optical sensor.
Illustration 15. The cropping system of any preceding or subsequent illustrations or combination of illustrations, wherein the optical sensor is a laser-based optical sensor.
Illustration 16. The cropping system of any preceding or subsequent illustrations or combination of illustrations, wherein the optical sensor is mounted at an angle between a rolling direction and a width direction defined by the cropping system for the metal slab.
Illustration 17. The cropping system of any preceding or subsequent illustrations or combination of illustrations, wherein the angle is from 45° to less than 90°, inclusive, relative to the width direction.
Illustration 18. The cropping system of any preceding or subsequent illustrations or combination of illustrations, wherein the optical sensor is configured to detect the defect in a thickness direction of the metal slab.
Illustration 19. The cropping system of any preceding or subsequent illustrations or combination of illustrations, wherein the optical sensor is a first optical sensor, wherein the cropping length system further comprises a second optical sensor, wherein the first optical sensor and the second optical sensor are each configured to detect the defect in a thickness direction of the metal slab, wherein the first optical sensor is at a first angle between a rolling direction and a width direction defined by the cropping system for the metal slab, and wherein the second optical sensor is at a second angle different from the first angle and between the rolling direction and the width direction.
Illustration 20. The cropping system of any preceding or subsequent illustrations or combination of illustrations, wherein the controller is configured to determine the cropping location by determining an overall length of the defect, wherein the controller is configured to determine the overall length of the defect by: determining a measured length of the defect based on the detection by the optical sensor; and adding a hidden length of the defect to the measured length of the defect to determine the overall length of the defect.
Illustration 21. The cropping system of any preceding or subsequent illustrations or combination of illustrations, wherein the hidden length of the defect is a predetermined, estimated hidden length.
Illustration 22. A method of cropping a metal slab with a cropping system, the method comprising: receiving, from an optical sensor, a detection of a defect in an end of the metal slab; determining a cropping location in the metal slab based on the detected defect by the optical sensor; and controlling the metal slab relative to a cropping device of the cropping system based on the determined cropping location.
Illustration 23. The method of any preceding or subsequent illustrations or combination of illustrations, further comprising detecting the defect in the end of the metal slab with the optical sensor while the optical sensor is mounted at an angle between a rolling direction and a width direction defined by the cropping system for the metal slab.
Illustration 24. The method of any preceding or subsequent illustrations or combination of illustrations, wherein determining the cropping location comprises determining an overall length of the defect, wherein determining the overall length of the defect comprises: determining a measured length of the defect based on the detection by the optical sensor; and adding a hidden length of the defect to the measured length of the defect to determine the overall length of the defect.
Illustration 25. The method of any preceding or subsequent illustrations or combination of illustrations, wherein determining the overall length of the defect further comprises determining the hidden length of the defect based on modelling.
Illustration 26. A cropping system for cropping a metal slab, the cropping system comprising: a cropping length system comprising a first optical sensor configured to detect a defect in an end of the metal slab; and a slab positioning system comprising a second optical sensor configured to measure a position of the end of the metal slab relative to a cropping device of the cropping system; and a controller configured to: determine a cropping location in the metal slab based on the detected defect from the first optical sensor; determine an actual position of the cropping location relative to the cropping device based on the measured position of the end of the metal slab from the optical sensor; and generate a position control response based on the actual position of the cropping location relative to the cropping device.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12” and any one of which may be referred to generically as a device “12”. In the figures and the description, like numerals are intended to represent like elements. As used herein, the meaning of “a,” “an,” and “the” includes singular and plural references unless the context clearly dictates otherwise.

The above-described aspects are merely possible examples of implementations, merely set forth for a clear understanding of the principles of the present disclosure. Many variations and modifications may be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A cropping system for cropping a metal slab, the cropping system comprising a slab positioning system, the slab positioning system comprising:
an optical sensor configured to measure a position of an end of the metal slab relative to a cropping device of the cropping system; and
a controller communicatively coupled to the optical sensor and configured to generate a position control response based on the measured position of the end of the metal slab by the optical sensor.

2. The cropping system of claim 1, wherein the optical sensor is a first optical sensor configured to measure the position of the end of the metal slab upstream from the cropping device, and wherein the slab positioning system further comprises a second optical sensor configured to measure the position of the end of the metal slab downstream from the cropping device.

3. The cropping system of claim 1, wherein the optical sensor is positioned above a passline for the metal slab through the cropping system, and wherein the optical sensor is configured to measure the metal slab in a plane extending in a direction parallel to a processing direction of the metal slab.

4. The cropping system of claim 1, wherein the optical sensor is a laser-based optical sensor.

5. The cropping system of claim 1, wherein the optical sensor is a thermal camera.

6. The cropping system of claim 1, wherein the controller is configured to position the metal slab relative to the cropping device or generate a display on a human machine interface as the position control response.

7. The cropping system of claim 1, wherein the optical sensor is a machine vision camera positioned above a passline for the metal slab through the cropping system.

8. A cropping system for cropping a metal slab, the cropping system comprising a slab positioning system, the slab positioning system comprising:
an optical sensor configured to detect an end of the metal slab; and
a controller communicatively coupled to the optical sensor and configured to:
receive visual data from the optical sensor comprising the detected end of the metal slab;
measure a length of a target region of the end of the metal slab based on the received visual data; and
generate a position control response based on the measured length of the target region of the end of the metal slab.

9. The cropping system of claim 8, wherein the optical sensor is a machine vision camera positioned above a passline for the metal slab through the cropping system.

10. The cropping system of claim 8, wherein the optical sensor is a thermal camera.

11. The cropping system of claim 8, wherein the controller is configured to position the metal slab relative to a cropping device or generate a display on a human machine interface as the position control response.

12. The cropping system of claim 8, further comprising a cropping device for cropping the metal slab.

13. A cropping system for cropping a metal slab, the cropping system comprising a cropping length system, the cropping length system comprising:
an optical sensor configured to detect a defect in an end of the metal slab; and
a controller communicatively coupled to the optical sensor and configured to determine a cropping location in the metal slab based on the detected defect by the optical sensor.

14. The cropping system of claim 13, wherein the optical sensor is a laser-based optical sensor.

15. The cropping system of claim 13, wherein the optical sensor is mounted at an angle between a rolling direction and a width direction defined by the cropping system for cropping the metal slab.

16. The cropping system of claim 15, wherein the angle is from 45° to less than 90°, inclusive, relative to the width direction.

17. The cropping system of claim 13, wherein the optical sensor is configured to detect the defect in a thickness direction of the metal slab.

18. The cropping system of claim 13, wherein the optical sensor is a first optical sensor, wherein the cropping length system further comprises a second optical sensor, wherein the first optical sensor and the second optical sensor are each configured to detect the defect in a thickness direction of the metal slab, wherein the first optical sensor is at a first angle between a rolling direction and a width direction defined by the cropping system for cropping the metal slab, and wherein the second optical sensor is at a second angle different from the first angle and between the rolling direction and the width direction.

19. The cropping system of claim 13, wherein the controller is configured to determine the cropping location by determining an overall length of the defect, wherein the controller is configured to determine the overall length of the defect by:
determining a measured length of the defect based on the detection by the optical sensor; and
adding a hidden length of the defect to the measured length of the defect to determine the overall length of the defect.

20. The cropping system of claim 19, wherein the hidden length of the defect is a predetermined, estimated hidden length.
